(19) United States
(12) Patent Application Publication
(10) Pub. No.: US 2026/0048843 A1
(43) Pub. Date: Feb. 19, 2026

(54) Loading Large Equipment Through Aircraft Entry Door

(71) Applicant: The Boeing Company, Arlington, VA (US)

(72) Inventors: Austin K. Hancock, Seattle, WA (US); William Stephen Kelliher, Bellevue, WA (US)

(21) Appl. No.: 18/802,121

(22) Filed: Aug. 13, 2024

(51) Int. Cl. B64D 9/00

(52) U.S. Cl. CPC B64D 9/00

(57) ABSTRACT

A modular rail system for loading equipment through an aircraft entry door is provided. The rail system comprises a number of track adapters configured to attach to seat tracks in the floor of the aircraft and a number of detachable rail segments, wherein a subset of the rail segments is configured to attach to the track adapters at a prescribed angle relative to the seat tracks, wherein the angle is calculated to maximize clearance of equipment moved along the rail segments through the entry door based on the model of the aircraft.

### BACKGROUND INFORMATION

### Technical Field

The present disclosure relates generally to loading equipment onto an aircraft, and more specifically to a modular rail system that allows loading through a passenger entry door.

### Background

There are significant costs and risks associated with modifying an aircraft after initial production. Existing methods of retrofitting equipment into an aircraft after initial production require manually manipulating the equipment through the forward entry door, risking damage to aircraft structures, especially with larger pieces of equipment and the equipment itself. For cargo planes and refueling tankers, there is an alternative to loading equipment through the entry door, which is loading it through the cargo door. For tankers, this method frequently requires the removal of onboard equipment as needed to permit installation. However, this alternative is time consuming and cost prohibitive. Passenger aircraft do not have that as an option, and as such the only possible loading method is through a passenger entry door.

Therefore, it would be desirable to have a method and apparatus that take into account at least some of the issues discussed above, as well as other possible issues.

### SUMMARY

An illustrative embodiment provides a modular rail system for loading equipment through an aircraft entry door. The rail system comprises a number of track adapters configured to attach to seat tracks in the floor of the aircraft and a number of detachable rail segments, wherein a subset of the rail segments is configured to attach to the track adapters at a prescribed angle relative to the seat tracks, wherein the angle is calculated to maximize clearance of equipment moved along the rail segments through the entry door based on the model of the aircraft.

Another illustrative embodiment provides a modular rail system for loading equipment through an aircraft entry door. The rail system comprises a number of detachable rail segments comprising parallel rails connected by cross ties and a number of track adapters configured to attach at least one of the rail segments to seat tracks in the floor of the aircraft at a prescribed angle relative to the seat tracks. A number of rail carriages are configured to slide along the rails of the rail segments.

Another illustrative embodiment provides a method of loading equipment through an aircraft entry door. The method comprises connecting a number of track adapters to seat tracks in the floor of the aircraft. A first rail segment is connected to the track adapters, wherein the track adapters hold the rail segment at a prescribed angle relative to the seat tracks. A number of additional rail segments are then connected to the first rail segment. The prescribed angle aligns the rail segments along a straight path through the entry door based on the model of the aircraft, wherein a first subset of the rail segments are outboard the aircraft and a second subset of the rail segments, including the first rail segment are onboard the aircraft. Equipment is secured onto a number of rail carriages attached to the rail segments and configured to slide along the rail segments the first subset of rail segments outboard the aircraft. The equipment is slide along the rail segments through the entry door and into the aircraft. The equipment is removed from the rail segments, and the rail segments are then removed from the aircraft.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1A depicts a pictorial diagram illustrating fitting a console through an aircraft entry door;

FIG. 1B depicts a pictorial diagram illustrating fitting a larger sized console through the same aircraft entry door;

FIG. 2 depicts an exploded view of a modular rail system in accordance with an illustrative embodiment;

FIG. 3A depicts a top view of an assembled modular rail system in accordance with an illustrative embodiment;

FIG. 3B depicts a close up view of a rail section attached to a seat track via a track adapter in accordance with an illustrative embodiment;

FIG. 4A depicts a diagram illustrating rail carriages mounted to the rail segments in accordance with an illustrative embodiment;

FIG. 4B depicts a close up view of a rail carriage in accordance with an illustrative embodiment;

FIG. 5 depicts mounting adapters in accordance with an illustrative embodiment;

FIG. 6 depicts an illustration of the initial anchor rail segment installed onboard in accordance with an illustrative embodiment;

FIG. 7 depicts an illustration of an assembled modular rail system in accordance with an illustrative embodiment;

FIG. 8 depicts an illustration of an equipment console positioned on a lowered rear deck of the cargo loader in accordance with an illustrative embodiment;

FIG. 9 depicts an illustration of the equipment console on the elevated rear deck of the cargo loader in accordance with an illustrative embodiment;

FIG. 10 depicts an illustration of the equipment console loaded onto the outboard rail segments of the modular rail system in accordance with an illustrative embodiment;

FIG. 11 depicts a diagram illustrating a console moved into position over rail carriages using magnetic alignment features in accordance with an illustrative embodiment;

FIG. 12 depicts a diagram illustrating a console lowered onto rail carriages in accordance with an illustrative embodiment;

FIG. 13 depicts a diagram illustrating the console moved through the entry door on the modular rail system in accordance with an illustrative embodiment; and

FIG. 14 depicts a diagram illustrating the console onboard the aircraft after the modular rail system has been removed in accordance with an illustrative embodiment.

### DETAILED DESCRIPTION

The illustrative embodiments recognize and take into account that there are significant costs and risks associated with modifying an aircraft after initial production.

The illustrative embodiments also recognize and take into account that existing methods of retrofitting equipment into an aircraft after initial production require manually manipulating the equipment through the forward entry door, risking damage to aircraft structures, especially with larger pieces of equipment.

The illustrative embodiments also recognize and take into account that typically, the alternative to loading equipment through the entry door is loading it through the cargo door and removing onboard equipment as needed to permit installation. However, this alternative is time consuming and cost prohibitive.

The illustrative embodiments also recognize and take into account that for cargo planes and refueling tankers, there is an alternative to loading equipment through the entry door, which is loading it through the cargo door. For tankers, this method frequently requires the removal of onboard equipment as needed to permit installation

The illustrative embodiments provide a modular rail system to allow large equipment installation through the aircraft forward entry door. The rail system interfaces with the onboard seat tracks to establish and hold the angle from centerline, thereby allowing for maximum clearance through the door. The rail system enables large equipment installation through forward entry door when there either is not a cargo door or the use of it is precluded by the need to remove extensive amounts of equipment without risk to the door skin or other aircraft structures.

The rails are maintained parallel and at a fixed angle from centerline. Rails come apart in sections for ease of installation. The modularity of the rail system shown in the illustrative embodiments allows a single person to lift a rail segment. The rails and associated rail carriages are very low profile to allow for maximum vertical clearance.

Rail carriages interface with the relevant equipment with adapters and hold downs to mitigate tip-over risks. These hold downs provide the ability to fully constrain the equipment while moving through the forward entry door without risk to the aircraft structure.

The functionality of the rail system can be modified with adapters as shown in the illustrative embodiments to support different types of equipment with different sizes, shapes, weights, and centers of gravity.

Old equipment can be removed through the forward entry door using this equipment and the newer, larger, equipment installed through the same forward entry door, all with minimal onboard aircraft modification and time.

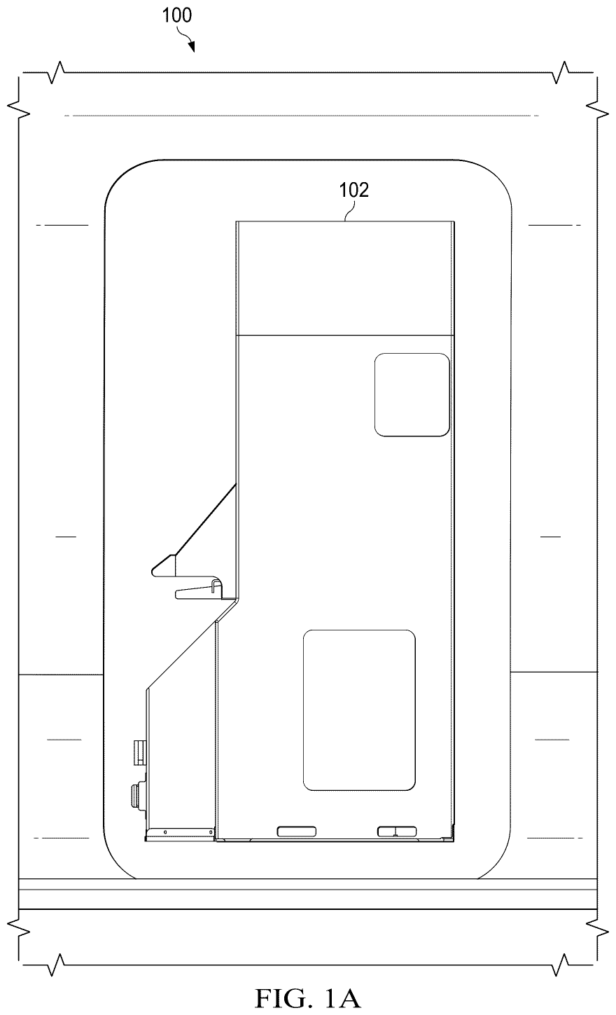

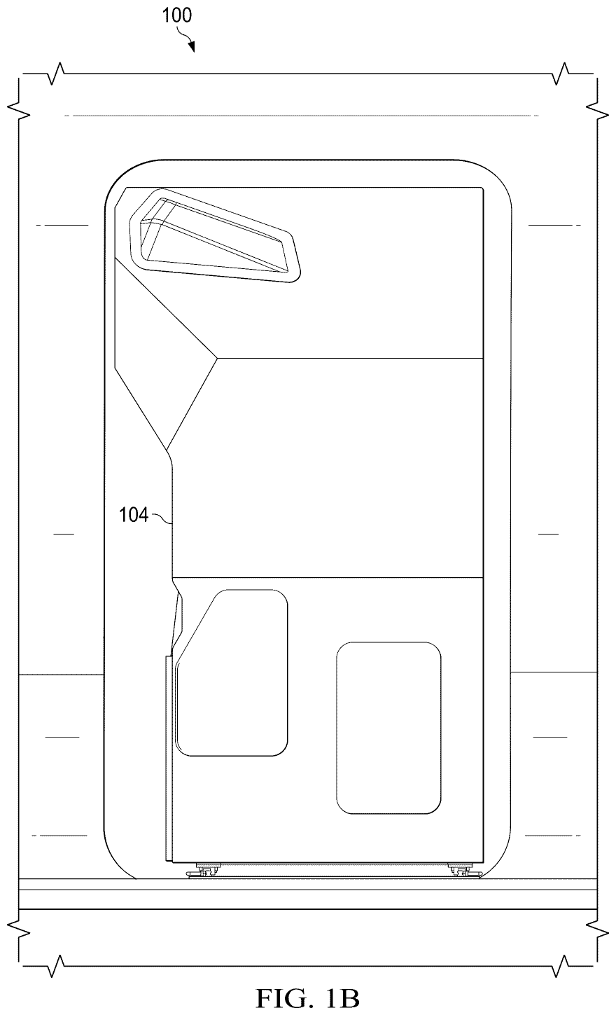

FIGS. 1A and 1B depict pictorial diagrams illustrating fitting different sized consoles through the same aircraft entry door. As shown in FIG. 1A, the profile of Console A 102 has a considerably greater clearance and margin of error than Console B 104 in FIG. 1B when moving through entry door frame 100.

In the present example, Console A 102 has a clearance of 6.4 inches (16.3 cm) at the top, 4.3 inches (10.9 cm) one both sides, and 3.8 inches (9.6 cm) at the lower right corner. Such clearance might provide sufficient margins of error to manually manipulate Console A 102 through the entry door frame 100 with a relatively low risk of damage to the aircraft.

In contrast, Console B 104 in has a substantially larger profile with very sparce clearances of 1.3 inches (3.3 cm) and 1.84 inches (4.7 cm) at the upper left and right corners, respectively, and only 0.92 inches (2.3 cm) at the lower right corner. Such small clearances make it highly unlikely that Console B 104 can be manually maneuvered through entry door frame 100 without causing damage.

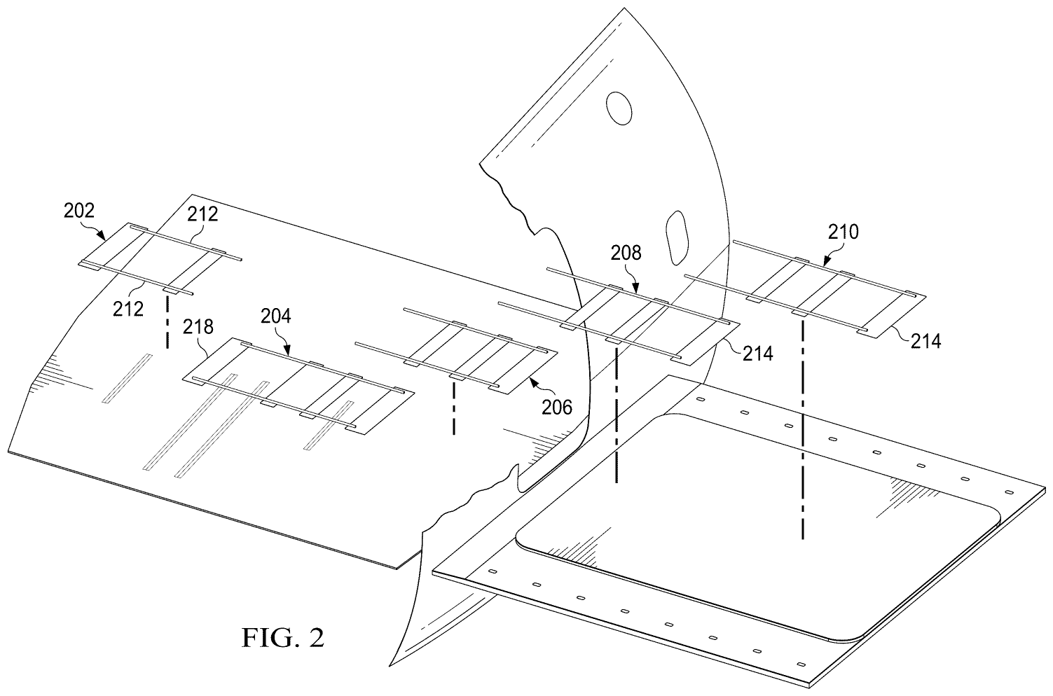

FIG. 2 depicts an exploded view of a modular rail system in accordance with an illustrative embodiment. In the present example, the modular rail system comprises five rail segments 202, 204, 206, 208, 210. Each rail segment 202-210 comprises pair of parallel rails 212 connected by a number of cross ties 214. The rail segments are joined by splice ties 218 at the common ends of the rail segments. The splice ties 218 are configured for attachment of rails of an adjacent rail segment, allowing the rails segments 202-210 to be connected together.

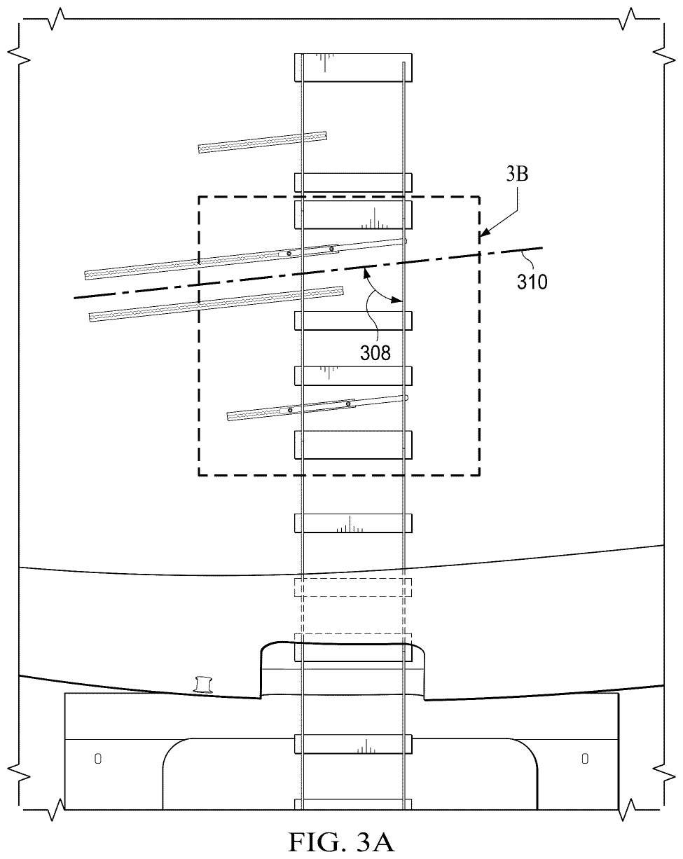

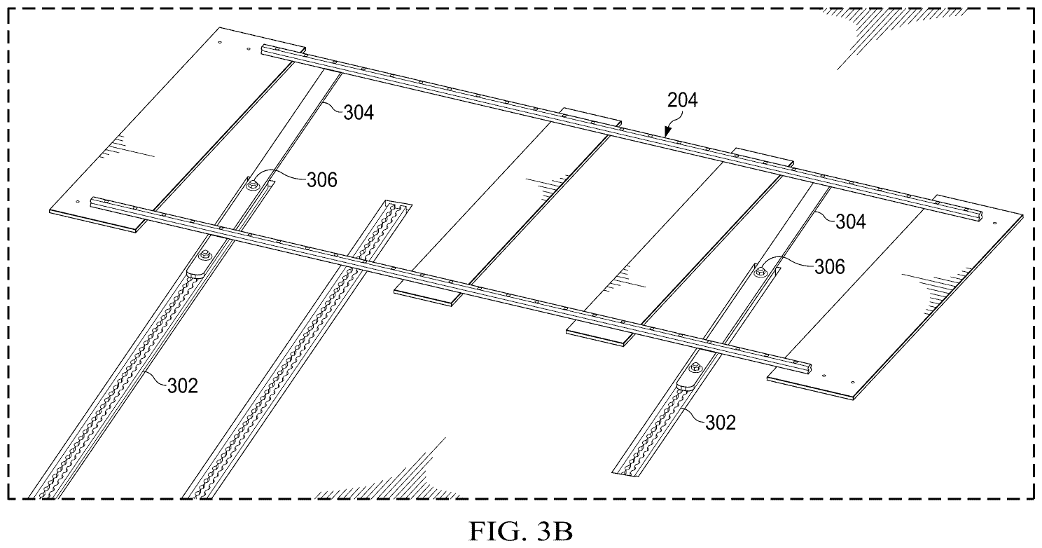

Depending on the model of aircraft, at least one of the rail segments (in this example, rail segment 204) is configured to connect to track adapters that attach to seat tracks in the floor of the aircraft (see FIG. 3).

FIG. 3A depicts a top view of an assembled modular rail system in accordance with an illustrative embodiment. FIG. 3B depicts a close up view of a rail section attached to a seat track via a track adapter.

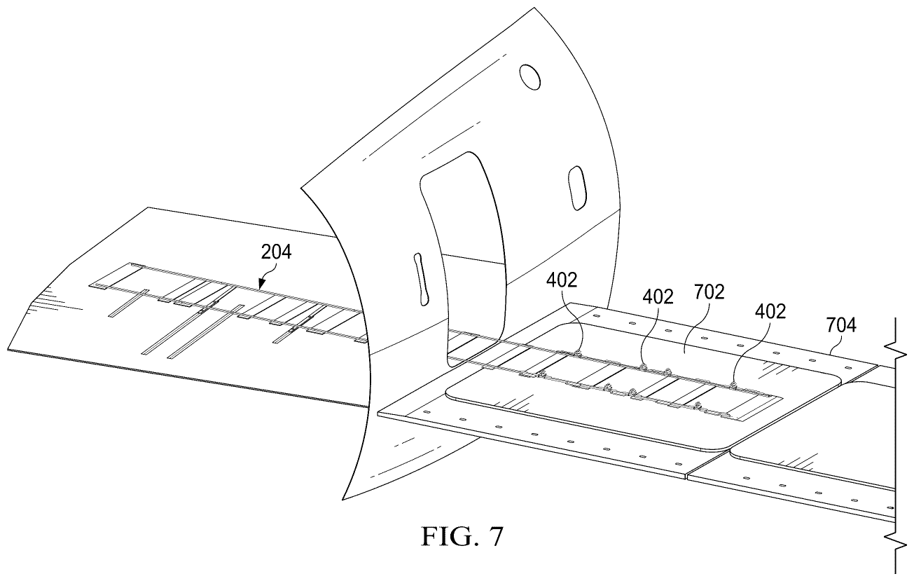

When assembled, the rail segments form a continuous track from the aircraft cabin, through the entry door, and out onto a cargo loader (see FIG. 7).

Rail segment 204 attaches to the preexisting seat tracks 302 of the aircraft via track adapters 304 (see FIG. 3). The track adapters 304 are configured to engage the specific type of seat tracks 302 (e.g., C-tracks) via pins 306.

The track adapters 304 anchor rail segment 204 to seat tracks 302 at a specified angle 308 relative to the centerline 310 of the aircraft that ensures the assembled modular rail system forms a straight path through the entry door due to the curvature of the fuselage and maximizes clearance through the door. This specified angle 308 is determined by the model of the aircraft in question.

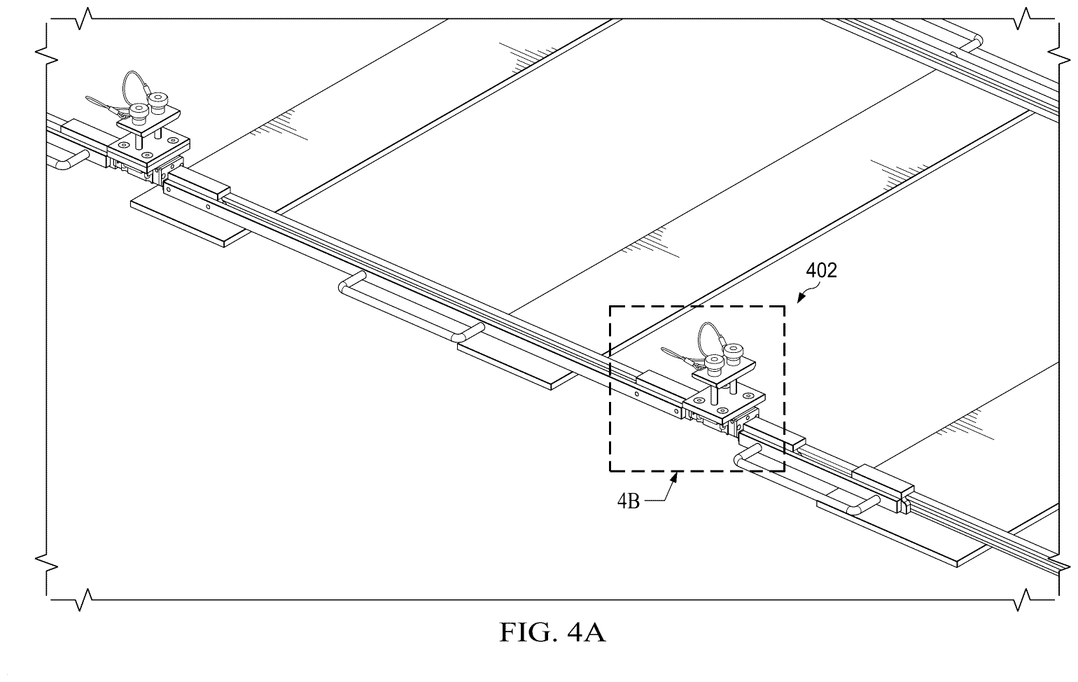

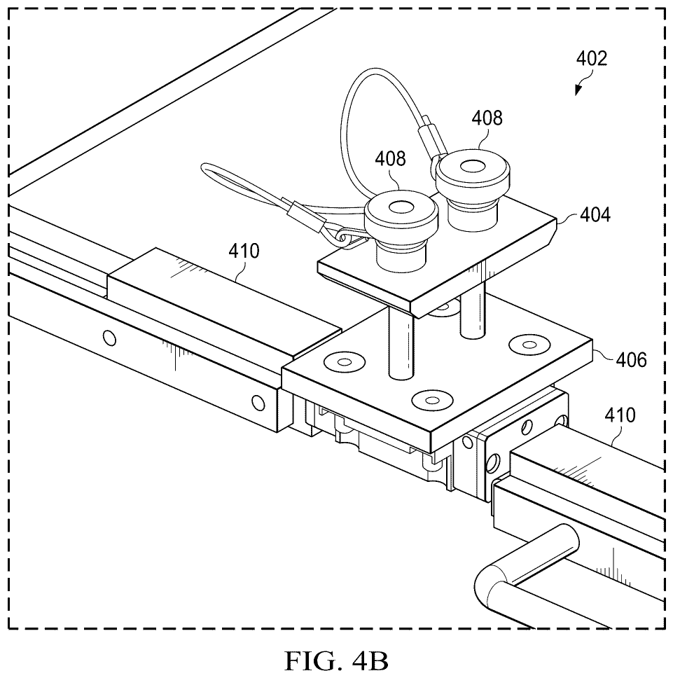

FIG. 4A depicts a diagram illustrating rail carriages mounted to the rail segments in accordance with an illustrative embodiment. FIG. 4B depicts a close up view of a rail carriage. The rail carriages 402 are configured to slide along the rail segments. Each rail carriage 402 comprises an upper plate 404 and lower plate 406. Thumb nuts 408 on top of the upper plate 404 are used to retain the bottom of the equipment moved along the rail segments and prevent the equipment from tipping over and falling off the rails. Other types of fasteners may also be mounted on the tops of the rail carriages 402.

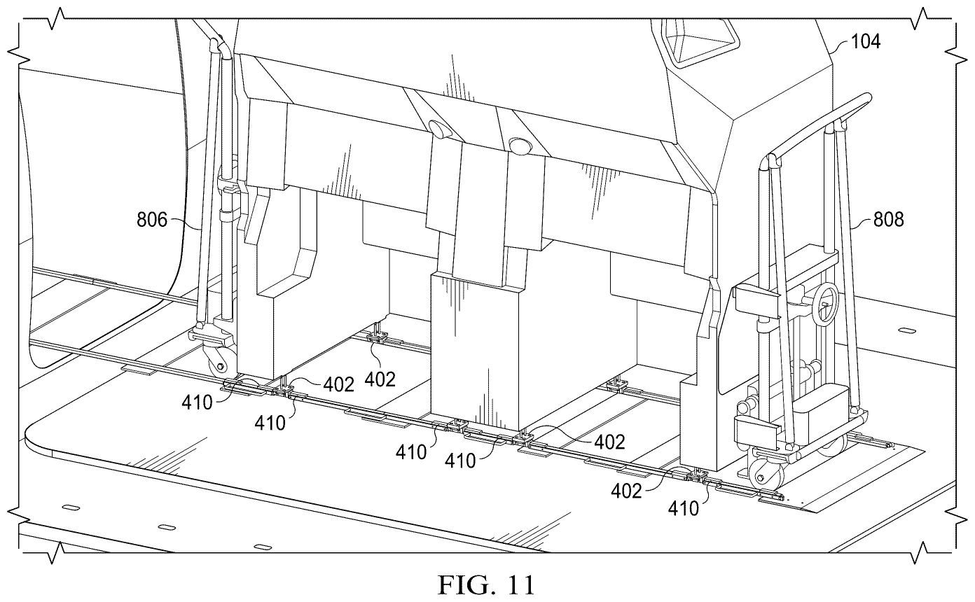

The rail carriages 402 also include magnetic alignment fixtures 410. These magnetic alignment fixtures 410 are complementary to mounting features of the equipment moved along the rail segments and assist in spacing the rail carriages according to the footprint of the equipment in question (see FIG. 11).

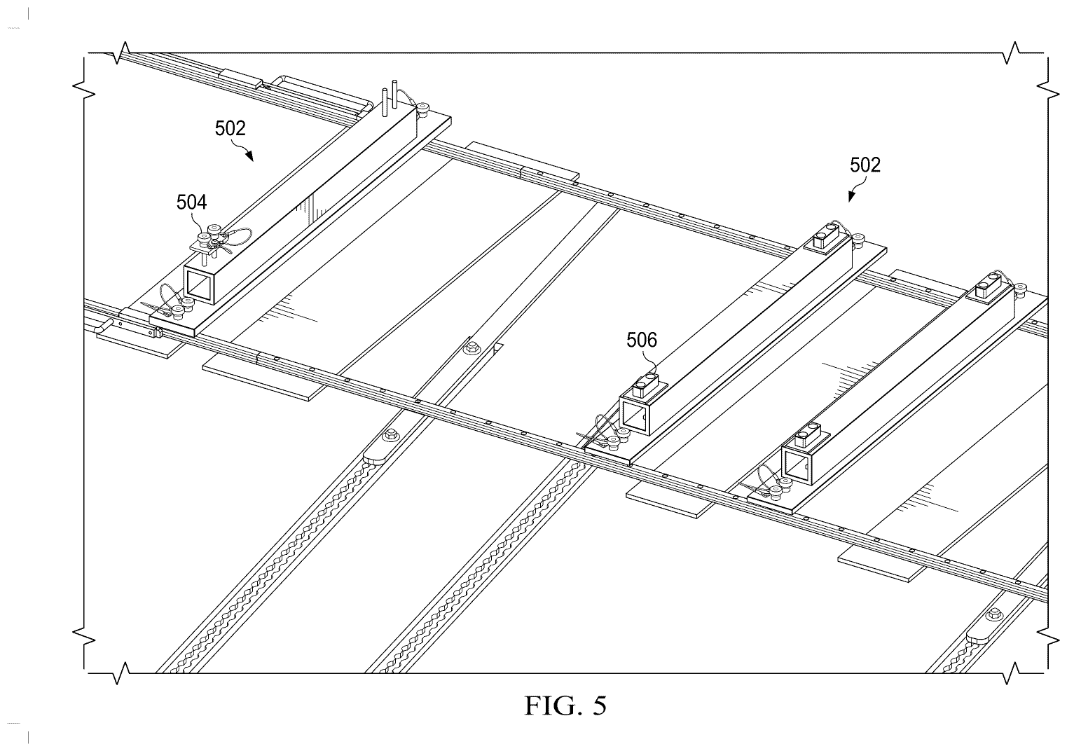

FIG. 5 depicts mounting adapters in accordance with an illustrative embodiment. Some equipment to be loaded into the aircraft might have a footprint that is narrower than the rail segments. Mounting adapters 502 can be mounted on top of rail carriages 402 and connect rail carriages on opposite rails, thereby forming bridges that parallel the cross ties.

As shown in FIG. 5, mounting adapters 502 have mounting points 504, 506 that are spaced more narrowly than the rails of the rail segments, thereby accommodating a narrower equipment footprint than the rails. In the present example, mounting points 504, 506 are different types of fasteners. Other types of fasteners may also be used according to the equipment being installed.

In the example mounting adapters 502 shown in FIG. 5, the mounting points 504, 506 are also elevated above the rail carriages, thereby accommodating equipment that requires a greater ground clearance than the rail carriages.

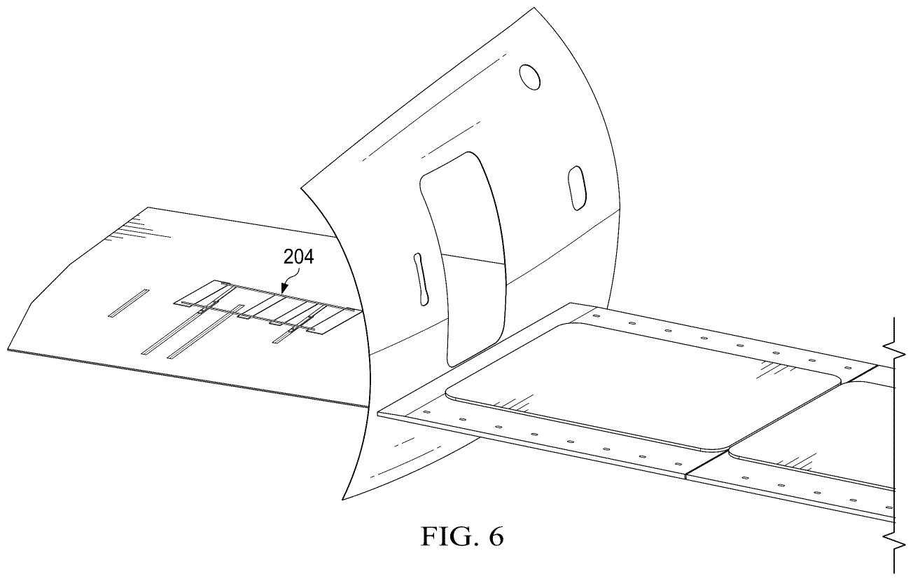

FIGS. 6-14 illustrate a process of loading an equipment console onto an aircraft through the forward entry door using the modular rail system of the illustrative embodiments.

FIG. 6 depicts an illustration of the initial anchor rail segment installed onboard. In this initial stage, the anchor rail segment is fastened to the seat tracks of the aircraft via track adapters, establishing the angle outboard through the entry door when the rest of the rail segments are connected.

FIG. 7 depicts an illustration of an assembled modular rail system. At this stage, the other rail segments are connected to the anchor segment, forming a continuous rail line from inboard the aircraft, through the entry door, and outboard onto a cargo palette 702 on the forward deck of a cargo loader 704. A number of rail carriages 402 are mounted onto the outboard rail segments.

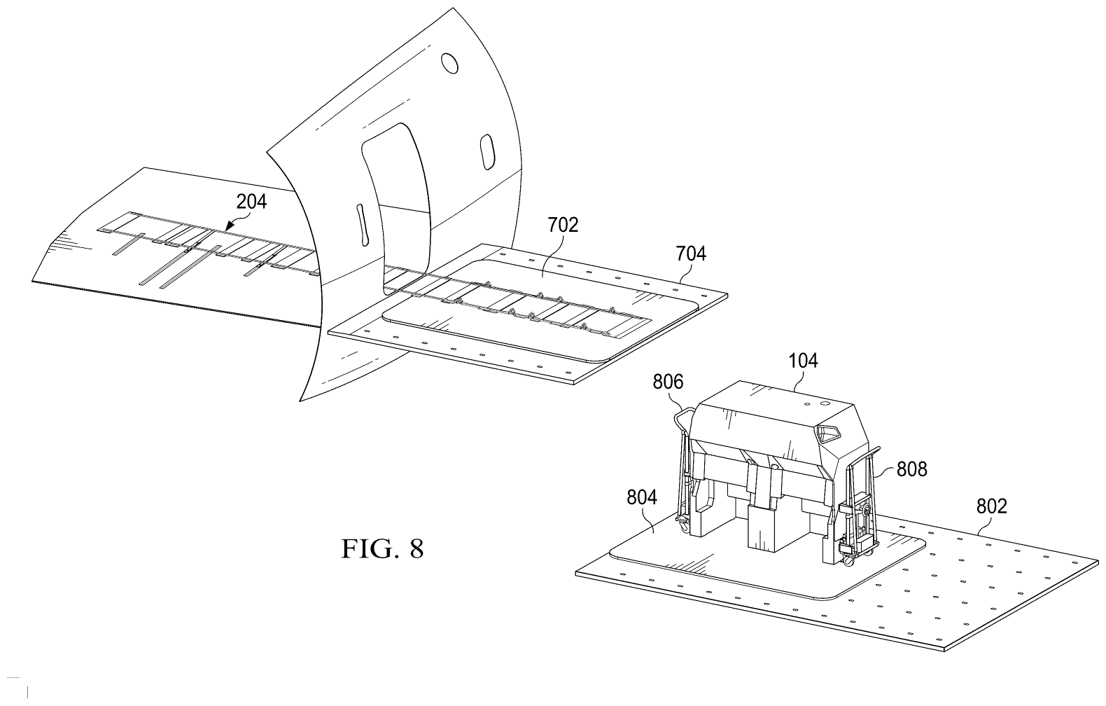

FIG. 8 depicts an illustration of an equipment console positioned on a lowered rear deck 802 of the cargo loader. Console 104 can be loaded onto cargo palette 804 on rear deck 802 by a forklift. Dollies 806, 808 can be used to raise the console 104 to remove the console crate (not shown) and to move the console onto the outboard rail segments when the rear deck 802 is elevated.

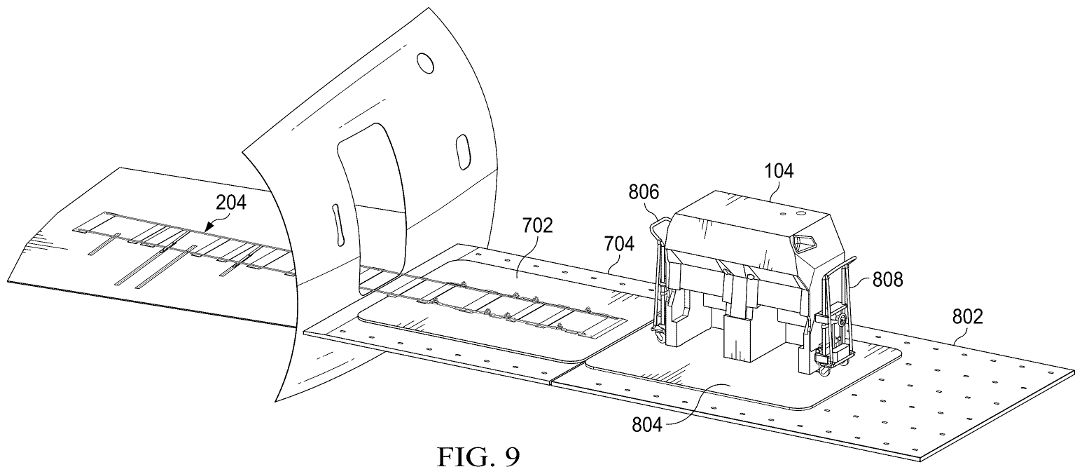

FIG. 9 depicts an illustration of the equipment console on the elevated rear deck of the cargo loader. At this stage, the rear deck of the cargo loader is elevated to be even with the forward deck.

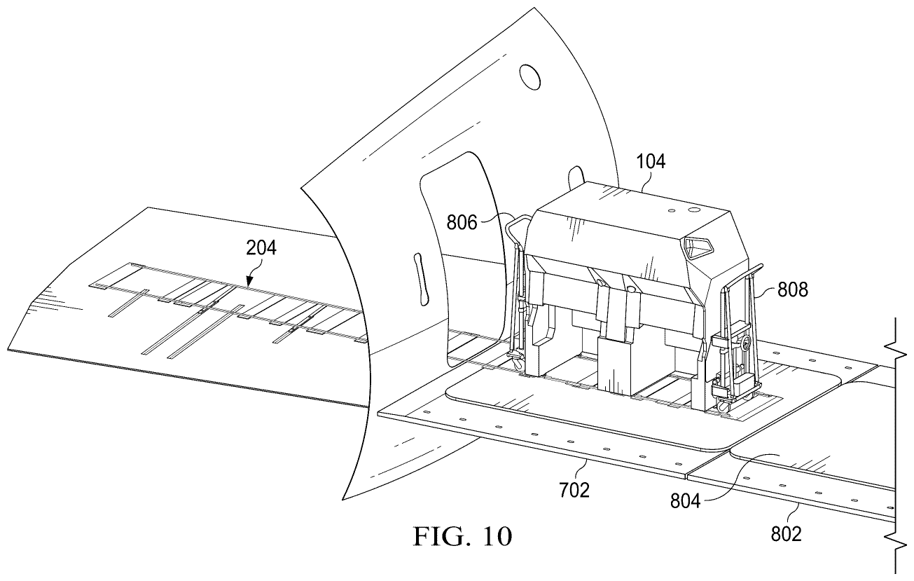

FIG. 10 depicts an illustration of the equipment console loaded onto the outboard rail segments of the modular rail system. Dollies 806, 808 can be used to move the console 104 into position from the elevated rear deck of the cargo loader onto the outboard rail segment on the forward deck.

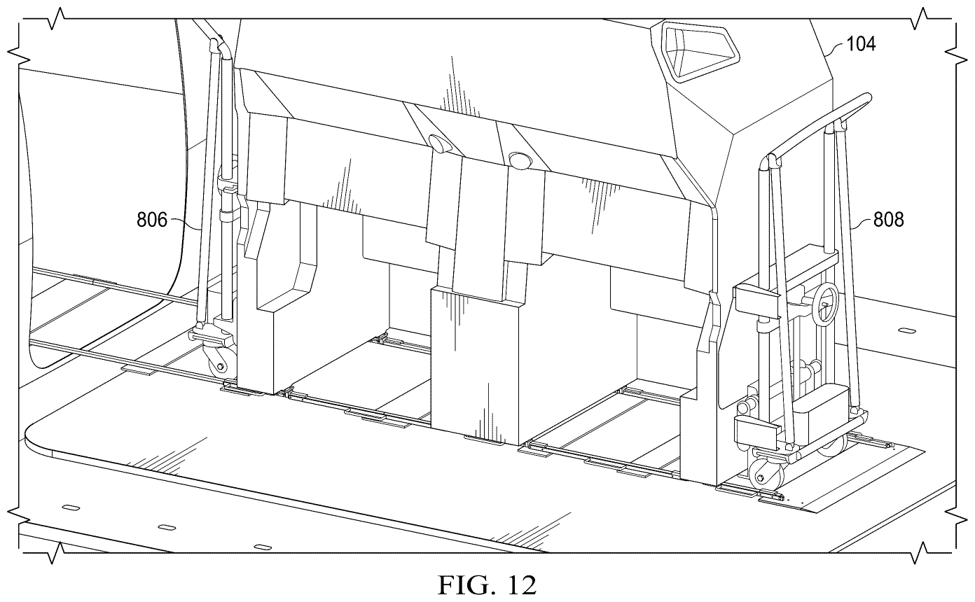

FIGS. 11 and 12 provide a closer view of the use of the magnetic alignment features and rail carriages to position the console onto the modular rail system.

In FIG. 11 the magnetic alignment features 410 are used to properly align the console 104 with the rail carriages 402. The console 104 can be moved into position with dollies 806, 808.

FIG. 12 illustrates the console lowered onto the rail carriages. After the console 104 is properly aligned, it is lowered by the dollies 806, 808 onto the rail carriages. The thumb nuts on top of the rail carriages slide into console mount locations and retain the console 104 in place on the rails and prevent it from tipping over. The dollies 806, 808 can then be removed.

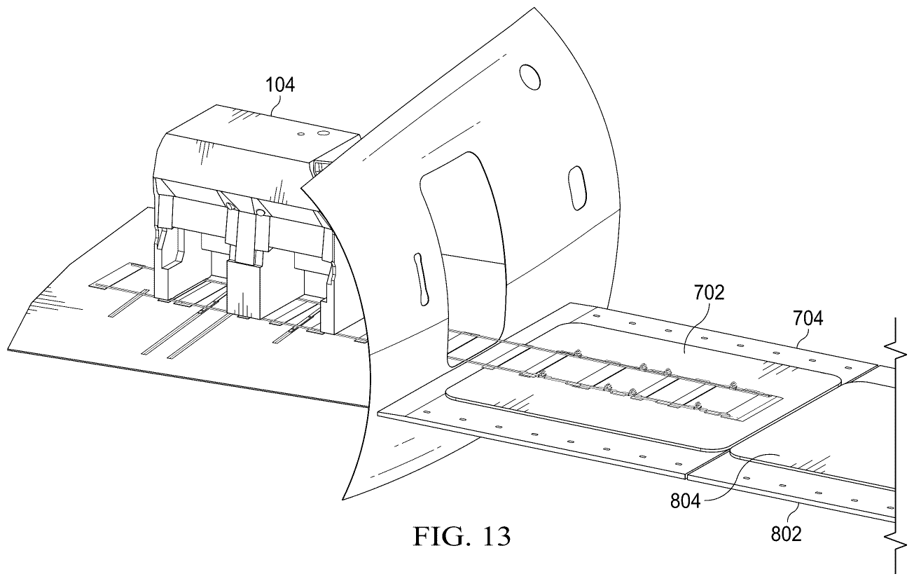

FIG. 13 depicts a diagram illustrating the console moved through the entry door on the modular rail system. At this stage, the console has translated inboard along the rails and is now inside the aircraft cabin. As explained above, the prescribed angle of the rails to the seat tracks inside the aircraft provides a straight path that maximizes clearance through the entry door, accounting for the curvature of the forward fuselage.

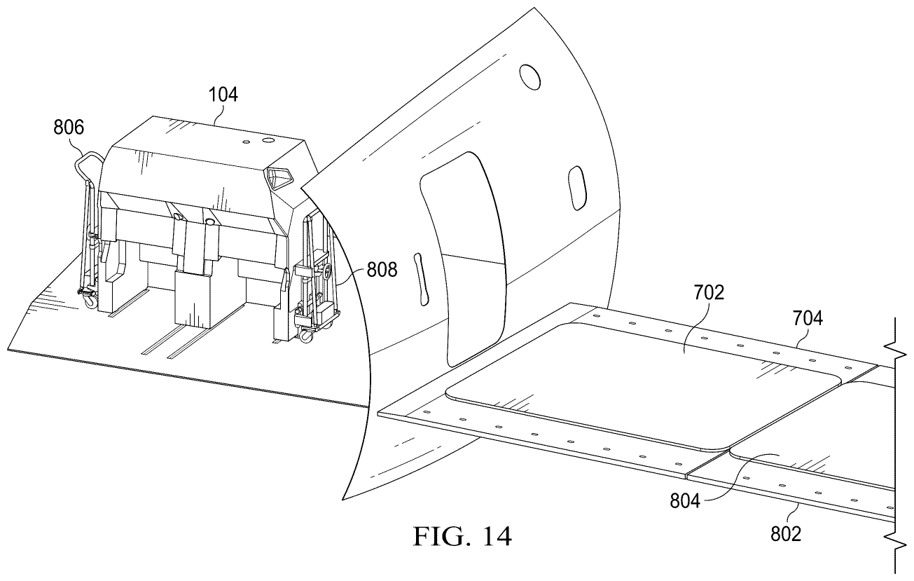

FIG. 14 depicts a diagram illustrating the console onboard after the modular rail system has been removed. After the console is onboard, the dollies can be used to lift it off of the rail carriages and rails, allowing the modular rail system to be disassembled and removed. The dollies can then be used to translate the console into a final position within the aircraft. In the present example, the seat tracks are the final fixture point for the console.

As used herein, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present.

In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of different types of networks” is one or more different types of networks. In illustrative example, a “set of” as used with reference items means one or more items. For example, a set of metrics is one or more of the metrics.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A modular rail system for loading equipment through an aircraft entry door, the rail system comprising:
a number of track adapters configured to attach to seat tracks in the floor of the aircraft; and
a number of detachable rail segments, wherein a subset of the rail segments is configured to attach to the track adapters at a prescribed angle relative to the seat tracks, wherein the angle is calculated to maximize clearance of equipment moved along the rail segments through the entry door based on the model of the aircraft.

2. The modular rail system of claim 1, further comprising a number of rail carriages attached to the rail segments and configured to slide along the rail segments, wherein the rail carriages include magnetic alignment fixtures complementary to mounting features of the equipment moved along the rail segments to assist spacing of the rail carriages according to the footprint of the equipment.

3. The modular rail system of claim 2, wherein the rail carriages comprise plates with thumb nuts to retain the bottom of the equipment moved along the rail segments.

4. The modular rail system of claim 2, further comprising a number of mounting adapters configured to connect rail carriages on opposite rails, wherein the mounting adapters comprise mounting points that are spaced more narrowly than the rails of the rail segments.

5. The modular rail system of claim 4, wherein the mounting points are elevated above the rail carriages.

6. The modular rail system of claim 1, wherein the rail segments each comprise parallel rails connected by a number of cross ties.

7. The modular rail system of claim 6, wherein one cross tie on each rail segment comprises a splice tie configured for attachment of rails of an adjacent rail segment.

8. A modular rail system for loading equipment through an aircraft entry door, the rail system comprising:
a number of detachable rail segments comprising parallel rails connected by cross ties;
a number of track adapters configured to attach at least one of the rail segments to seat tracks in the floor of the aircraft at a prescribed angle relative to the seat tracks; and
a number of rail carriages configured to slide along the rails of the rail segments.

9. The modular rail system of claim 8, wherein the prescribed angle is calculated to align the rail segments along a straight path through the entry door based on the model of the aircraft.

10. The modular rail system of claim 8, wherein the rail carriages comprise magnetic alignment fixtures complementary to mounting features of the equipment moved along the rail segments.

11. The modular rail system of claim 8, wherein the rail carriages comprise plates with thumb nuts to retain the bottom of the equipment.

12. The modular rail system of claim 8, wherein the rail segments further comprise splice ties configured to attachment rails of adjacent rail segments.

13. The modular rail system of claim 8, further comprising a number of mounting adapters configured to connect rail carriages on opposite rails, wherein the mounting adapters comprise mounting points that are spaced more narrowly than the rails of the rail segments.

14. A method of loading equipment through an aircraft entry door, the method comprising:
connecting a number of track adapters to seat tracks in the floor of the aircraft;
connecting a first rail segment to the track adapters, wherein the track adapters hold the rail segment at a prescribed angle relative to the seat tracks;
connecting a number of additional rail segments to the first rail segment, wherein the prescribed angle aligns the rail segments along a straight path through the entry door based on the model of the aircraft, wherein a first subset of the rail segments are outboard the aircraft and a second subset of the rail segments, including the first rail segment are onboard the aircraft;
securing equipment onto a number of rail carriages attached to the rail segments and configured to slide along the rail segments the first subset of rail segments outboard the aircraft;
sliding the equipment along the rail segments through the entry door and into the aircraft;
removing the equipment from the rail segments; and
removing the rail segments from the aircraft.

15. The method of claim 14, wherein the rail carriages include magnetic alignment fixtures complementary to mounting features of the equipment moved along the rail segments to assist spacing of the carriages according to the footprint of the equipment.

16. The method of claim 14, wherein the rail carriages comprise plates with thumb nuts to retain the bottom of the equipment moved along the rail segments.

17. The method of claim 14, wherein the rail segments further comprise a number of mounting adapters configured to connect rail carriages on opposite rails, wherein the mounting adapters comprise mounting points that are spaced more narrowly than the rails of the rail segments.

18. The method of claim 17, wherein the mounting points are elevated above the rail carriages.

19. The method of claim 14, wherein the rail segments each comprise parallel rails connected by a number of cross ties.

20. The method of claim 19, wherein one cross tie comprises on each rail segment a splice tie configured for attachment of rails of an adjacent rail segment.
